(19) United States
(12) Patent Application Publication
(10) Pub. No.: US 2006/0032746 A1
(43) Pub. Date: Feb. 16, 2006

(54) Method and device for contacting a microfluidic structure

(76) Inventors: Thomas Knott, Kusterdingen (DE); Alfred Stett, Reutlingen (DE); Peter Sygall, Riethoven (NL); Peter von Stiphout, Helmond (NL)

Correspondence Address: KNOBBE MARTENS OLSON & BEAR LLP, 2040 MAIN STREET, FOURTEENTH FLOOR, IRVINE, CA, 92614, US

(21) Appl. No.: 11/203,668

(22) Filed: Aug. 12, 2005

Related U.S. Application Data
(63) Continuation of application No. PCT/EP04/01284, filed on Feb. 12, 2004.

(30) Foreign Application Priority Data
Feb. 14, 2003 (DE) 103 07 227.6

(51) Int. Cl. G01N 27/26

(52) U.S. Cl. 204/450; 204/600

(57) ABSTRACT

The present invention relates to a method and a device for contacting a microfluidic structure. The device comprises a receptacle for the microfluidic structure and also a contact unit. According to one aspect of the invention, the contact unit has at least one hollow needle, which is designed for piercing a layer of elastic material which is provided on the microfluidic structure.

### CROSS-REFERENCE TO RELATED APPLICATIONS

This is a continuation application of International Patent Application PCT/EP 2004/001284, filed Feb. 12, 2004, designating the United States and published in German as WO 2004/071660 A1, which claims priority to German Application No. 103 07 227.6, filed Feb. 14, 2003.

### BACKGROUND OF THE INVENTION

1. Field of the Invention

The present invention relates to a method for contacting a microfluidic structure, which has at least one microchannel and an access opening connected to it for introducing a first fluid.

The invention also relates to a device for contacting such a microfluidic structure, with a receptacle for the microfluidic structure and with a contact unit with at least one fluid channel, which fluid channel can be connected to the access opening of the microfluidic structure.

Finally, the invention also relates to a corresponding microfluidic structure itself, which is optimized for application of the method and for use in the device.

2. Description of the Related Art

A method and a device of the kind mentioned above are known for example from DE 199 28 410 C2.

For the purposes of the present invention, microfluidics is a technical field which is concerned with the development and application of equipment and methods with which extremely small amounts of a fluid (liquid or gas) are handled. Typically, the amount of fluid lies in the range of nanoliters (10-9 liters) or even picoliters (10-12 liters). On account of these extremely small amounts of fluid, on the one hand a miniaturization of applica-tions known per se can be achieved. In addition, however, microfluidics also offer the possibility of opening up new application areas. An application which is preferred within the scope of the present invention is the pharmaceutical, chemical and/or biochemical analysis and also synthesis of substances, in particular under the term “lab-on-a-chip”. In this case, extremely small amounts of a substance to be tested are analyzed with the aid of a microfluidic structure, which makes possible, inter alia, short analysis times and reliable results even in the case of extremely small amounts of the substance sample. However, in principle the invention is not restricted to this currently preferred application area and can also be used in other cases in which microfluidic structures have to be contacted.

With regard to the preferred application, for the purposes of the present invention microflu-idic structures comprise a carrier (“chip”), which has a number of microchannels for receiving fluids in the amounts mentioned above and conducting them in a specifically defined manner. The microchannels have dimensions corresponding to the amounts of fluid in the range from several 10s to 100s of micrometers. Such structures are nowadays produced by methods such as those similarly known from the area of microelectronics. Generally, the fine microchannels are produced with the aid of etching processes.

In view of the small dimensions, it is understandable that the contacting of the microfluidic structures, and in particular the introduction of the fluid or fluids into the microchannels, represents a technical challenge. Various approaches to meeting this challenge are known in the prior art.

A first, quite simple approach is to provide the microfluidic structure with enlarged, cup-shaped or funnel-shaped access openings, into which a liquid can be instilled with the aid of a pipette. From the relatively large access opening, the liquid then penetrates into the microchannel or microchannels on account of capillary forces. This approach is disclosed, for example, in US 2002/0185377 A1. In order to eliminate problems associated with this simple approach, the same document also proposes an arrangement in which a multiplicity of pins are arranged on a movable carrier. With the aid of the pins, drops of a liquid are formed and the pins are subsequently made to enter cup-shaped access openings on the microfluidic structure. For the filling of the microchannels, the capillary forces that are present are likewise used in this case.

An approach that is often proposed and used in practice for the contacting of microfluidic structures is to fasten to the access openings small capillary tubes, to which an external periphery can then be connected. Examples of this type of contacting are to be found in U.S. Pat. No. 5,890,745, U.S. Pat. No. 6,209,928 B1, U.S. Pat. No. 6,273,478 B1, WO 01/53794 A1 and in the publications “Micromachine Rubber O-Ring and Micro-Fluidic Couplers” by Yao et al., Proceedings IEEE Thirteenth Annual Conference on Micro Electro Mechanical Systems, pages 624-627, and “Novel Interconnection Technologies for Integrated Microfluidic Systems” by Gray et al., Sensors and Actuators 77 (1999) pages 57-65.

However, achieving a stable and sealed fastening of the capillary tubes to the microfluidic structure poses a problem here. One of the proposals made in the cited documents is to screw the capillary tubes into a clamping sleeve arranged on the microfluidic structure or to fasten them by means of press holders. For sealing, O-rings or elastomers arranged inside the clamping sleeve are proposed. However, the production and

handling of these means of contact, in particular the fitting of the seals, is laborious.

U.S. Pat. No. 6,443,179 B1 discloses an arrangement with a microfluidic structure which is arranged in a dual inline package, as known in a comparable way from microelectronics. The dual inline package makes possible what is known as transformation or reformatting, in that “macroscopic” fluid connections are provided and connected to the microscopic access openings of the actual microfluidic structure via internal channels in the package. This type of contacting appears to be well suited for applications in which, for example, a microflu-idic airbag sensor is to be combined with an electronic evaluation circuit. For pharmaceuti-cal and/or chemical series of tests, however, this type of contacting is too laborious and expensive, at least from today's perspective.

US 2002/0127149 A1 discloses an arrangement for contacting a microfluidic structure for chemical or biochemical series tests. The microfluidic structure is in this case inserted into a “macroscopic” holder, which has funnel-shaped access openings into which a liquid to be analysed can be pipetted. In order to transport the liquid to be analysed from the holder into the microchannels of the microfluidic structure, it is also proposed to close the access openings of the holder with a sealing plug after introducing the liquid and subsequently build up a positive pressure through the sealing plug by penetrating it with a syringe. However, it is expressly intended that the hollow needle of the syringe should not touch the liquid to be analysed.

DE 199 28 410 C2 discloses a device for operating a laboratory microfluidic structure. The microfluidic structure is contacted via connecting lines which are brought up to the access openings of the structure from the outside. However, the coupling of the connecting lines to the microfluidic structure is not described in any more detail.

Finally, it is known from an entirely different area, that is the area of medical practice, to push the cannula of a syringe through the rubber seal of a vessel, in order to remove liquid from the vessel to fill the syringe.

U.S. Pat. No. 5,756,905 describes, for example, an automatic injector for a gas chromatograph which has a needle which is made to enter a vessel through a rubber seal.

U.S. Pat. No. 5,639,423 describes a reaction chamber for chemical processes, in particular for carrying out the polymerase chain reaction (PCR), in which a window of silicone rubber is provided. This window can be penetrated by a thin needle, through which a reagent can be introduced into the reaction chamber.

U.S. Pat. No. 6,358,479 B1 describes a reaction block with various chambers in which chemical reactions can be carried out. Arranged on the reaction block is a multilayered structure comprising a membrane, a septum and a top plate. Passages are provided in the top plate in order to press the membrane onto the reaction chambers by means of gas pressure and seal them in this way. A probe can be introduced into the reaction chamber through the septum, the septum closing again when the probe is withdrawn.

### SUMMARY OF THE INVENTION

In view of the above, it is one object of the present invention to provide an alternative possibility for fluidically contacting a microfluidic structure quickly, reliably and variably.

This object is achieved according to one aspect of the invention by a method of the kind mentioned at the outset which comprises the following steps:
arranging a layer of elastic material above the access opening, in order to close the latter,
piercing of the layer by means of at least one hollow needle, and
introducing of the first fluid into the microchannel via the at least one hollow needle.

According to a further aspect of the invention, the object is achieved by a device of the kind mentioned at the outset in which the contact unit has at least one hollow needle, which is connected to the fluid channel and is designed for piercing a layer of elastic material, which layer is provided on the microfluidic structure and closes the access opening.

All up to now known approaches for contacting a microfluidic structure can be traced back to one of two approaches. In the case of one approach, a liquid is instilled into exposed access openings of the microfluidic structure over a “free path”. In the case of the other approach, the fluid is supplied via small capillary tubes fastened to the microfluidic structure. By contrast, the present invention proposes a novel, third way. Unlike in the case of pipetting or instilling, the fluid is introduced into the microfluidic structure with the aid of the at least one hollow needle through a closed system of channels, that is to say without a “free path”. This makes particularly reliable contacting possible, since the fluid is con-trolled up to final release within the structure. In addition, the closed feeding system allows not only liquids but also gases to be introduced into the microfluidic structure in a specifi-cally defined manner. Furthermore, contaminations of the fluid during the introduction into the microfluidic structure are avoided.

The use of a hollow needle entering into the access opening of the microfluidic structure also makes very variable contacting possible. In particular, it is easily possible with the aid of a number of hollow needles to introduce different fluids into a microfluidic structure in such a way that the substances are uncontaminated and specifically defined in each case. Moreover, the use of an entering hollow needle makes multiple contacting and detachment possible in a simple way. These advantages cannot be achieved with the previously known capillary tubes.

Finally, because of the layer closing the access opening, there is no longer any need for the laborious handling of sealing rings of a micro size when establishing the contacting or for the laborious fastening of capillary tubes of a micro size to the microfluidic structure by screwing, pressing and/or adhesively bonding them in.

In view of the above, the present invention also relates to a microfluidic structure with at least one microchannel and at least one access opening to the microchannel, a layer of elastic material which closes the access opening being provided.

A microfluidic structure of this type is suitable in particular for use in the method accord-ing to the invention and in the device according to the invention; it may in this case be provided as disposable material. In other words, the microfluidic structure is supplied with closed access openings and can be inserted into the novel device and then filled as desired.

The stated object is thereby achieved completely.

According to a further object, the hollow needle is guided in a sliding piece when it pierces the layer.

Expressed in different terms, when it pierces the layer, the hollow needle accordingly moves in relation to a sliding piece which ensures exact guidance of the hollow needle. The positioning accuracy of the hollow needle in relation to the microfluidic structure is thereby improved. Furthermore, the hollow needle can be stabilized in this way, which significantly reduces the risk of damage to the hollow needle and/or the elastic layer. The contacting is therefore even more reliable.

According to a still further object, during the piercing of the layer, the sliding piece is pressed onto the layer of elastic material, to be precise preferably with surface area contact.

This measure achieves the effect that, when it is pierced with the hollow needle, the elastic layer is stabilized, which has the consequence on the one hand of improved sealing of the microfluidic structure and on the other hand of counteracting damage to the hollow needle and/or the elastic layer. This configuration consequently makes even more reliable contact-ing possible, and also improved sealing when contacting takes place.

According to another object, before piercing said layer, the hollow needle is filled with the first fluid up to an outlet opening.

This configuration makes it possible to fill the microfluidic structure without any bubbles, which is of advantage in particular for the pharmaceutical and/or chemical analysis of substance samples, since defined analytical conditions are ensured as a result. The penetra-tion of contaminants into the microfluidic structure is also prevented even more reliably by this configuration.

According to another object, the microchannel is completely filled with a second fluid before the introduction of the first fluid. The second fluid is in this case preferably intro-duced into the microchannel with a second hollow needle, which pierces the elastic layer. Accordingly, the contact unit of the device according to the invention preferably has a number of hollow needles for piercing the layer, it preferably being possible for the number of hollow needles to be controlled separately from one another.

With this configuration, particularly variable filling of the microfluidic structure can be achieved, which allows varied and novel possibilities for analysis and synthesis. The use of a number of hollow needles also has the advantage that each fluid can be introduced into the microfluidic structure in an uncontaminated manner.

According to a still further object, the hollow needle is, or the number of hollow needles are inserted into the access opening with an adjustable depth of entry when the fluid is introduced. The preferred device accordingly has a positioning unit, which makes a variable depth of entry of the hollow needle (or the hollow needles) into the microchannel possible.

This configuration also provides a particularly variable possibility for the contacting of the microfluidic structure. This is so because the fluid can then be introduced at different heights into microchannels of the structure. In combination with the aforementioned configuration, in which a number of fluids are introduced into the microchannel, defined mixing regions can be produced in this way. Furthermore, a laminar partial flow of the first fluid can be embedded into a laminar enclosing flow of the second fluid, which offers novel possibilities for analysis and synthesis. A further advantage of the variable depth of entry is that the microchannels can optionally be filled “from above” or “from below”, for example to avoid the formation of gas bubbles within a liquid.

The elastic layer is furthermore preferably formed in such a way that the pore which is created when it is pierced with the hollow needle closes again of its own accord when the hollow needle is withdrawn.

This configuration offers a completely closed system when contacting of the microfluidic structure takes place. As an alternative to this, however, the elastic layer may also have (micro)pores from the outset, so that, although the access opening is covered by the elastic layer, it is not completely closed. By contrast, the present configuration has the advantage that gaseous fluids in particular can be processed unproblematically with the microfluidic structure. Moreover, contamination of the fluid or fluids introduced is prevented even better.

The layer closing the access opening is preferably provided on its side facing the microflu-idic structure with at least one recess, which lies above the at least one access opening.

Because a recess is now provided in the layer, it can be formed as a thick sealing layer with additional functions. The sealing layer serves on the one hand for the protection of the microfluidic structure. Because the layer can now be made relatively thick, it can at the same time be microstructured, whereby the sealing characteristics can be improved. For example, it is possible to provide it with protruding sealing beads, etc. Furthermore, microfluidic channels may be provided in the sealing layer, in order to make continuous perfusion possible on the microfluidic structure.

The layer thereby performs two functions, which in themselves exhibit opposing requirements. On the one hand, it is intended to make the layer thin and soft, in order that no punching effect by which material of the layer is transported to the microfluidic structure takes place when it is pierced. Furthermore, the thin and soft configuration can ensure that the layer can be repeatedly closed again.

On the other hand, it is intended to make the sealing layer thick, in order to be able to accept additional functions, such as for example further microchannels.

These opposing characteristics can be realized by the layer being made relatively thick, but recesses being provided in the layer above the access openings that are to be closed, on the bottom of which recesses the layer is made relatively thin and soft, so that it can be pierced from the outside with a needle without any problem. Now, it is also no longer required to make this layer relatively hard and provide it with low compliant flexibility, since the sealing layer can bulge inward into the recess without the risk of it touching the microfluidic structure.

According to another object, the layer is provided with a predetermined breaking point in the region of the access opening. In a preferred embodiment, such a predetermined break-ing point is a recess in the elastic layer, that is to say a weakening of the material. In another preferred embodiment, the elastic layer includes as a predetermined breaking point a small area of material of a particularly soft material, while the rest of the layer consists of a less elastic, that is to say harder, material. Furthermore, in the elastic layer there may also be, as a “predetermined breaking point”, a micropore, the diameter of which is equal to, or if appropriate smaller than, the outside diameter of the hollow needle.

The measure has the advantage that the piercing of the elastic layer with a microfine hollow needle is made easier, reducing the risk of damage to the layer and/or the hollow needle. Moreover, better reproducibility when contacting takes place can be achieved by this configuration.

In a further embodiment, the device according to the invention has an automatic mecha-nism for arranging the layer of elastic material on the microfluidic structure.

The automatic mechanism may comprise, for example, a web of the elastic material wound up on a reel, a portion of the web of material being applied to the microfluidic structure before the actual contacting. In another preferred embodiment, the elastic layer is formed as a kind of enclosing sheath, in which a

microfluidic structure is placed before the contacting. Furthermore, the elastic layer may also be provided in the form of prepared “pads” in a store, from which the automatic mechanism in each case removes a pad and places it on the microfluidic structure.

This configuration makes possible very simple and automated contacting of a multiplicity of microfluidic structures on the principle that is used as a basis here.

According to a further object, the layer of elastic material has on a side facing the micro-fluidic structure projecting beads, which form sealing lips around the access opening.

This configuration is particularly advantageous if the elastic layer is not firmly connected to the microfluidic structure, that is to say for example adhesively bonded on it, but rather placed loosely onto the microfluidic structure. In particular in combination with a sliding piece of a flat form, which presses the layer against the structure during contacting, par-ticularly good sealing can be achieved with the projecting beads.

According to a further object and for arranging the layer, the microfluidic structure is at least partially surrounded by an enclosing form of the elastic material.

This configuration, already indicated further above, makes particularly simple application of the elastic layer possible, to be precise both in the case of automated handling and in the case of manual handling. Moreover, an enclosing form has the advantage that the elastic layer cannot slip off the microfluidic structure, even without adhesive bonding or other means of fixing.

In a further embodiment, the at least one hollow needle has a penetrating tip.

As an alternative to this, it is also possible for the hollow needle to have a blunt end. However, the formation of a penetrating tip makes the piercing of the elastic layer easier, and consequently makes more dependable and reliable contacting possible. By contrast, a hollow needle without a penetrating tip is advantageous if the elastic layer already has micropores which can be pierced even without a penetrating tip, since in this case damage to the elastic layer is avoided.

It goes without saying that the features mentioned above and still to be explained below can be used not only in the respectively specified combination, but also in other combina-tions or on their own, without departing from the scope of the present invention.

### BRIEF DESCRIPTION OF THE DRAWINGS

Embodiments of the invention are represented in the drawing and are explained in more detail in the description which follows. In the drawing:

FIG. 1 shows a schematic representation of an embodiment of the device according to the invention,

FIGS. 2 to 7 show schematic representations of microfluidic structures which, according to one aspect of the present invention, are pro-vided with an elastic layer,

FIGS. 8 and 9 show a preferred embodiment for the contacting of a microflu-idic structure in a simplified representation,

FIGS. 10 and 11 show a further embodiment for the contacting of a microfluidic structure, and

FIGS. 12 to 14 show further embodiments for the contacting of a microfluidic structure.

### DETAILED DESCRIPTION OF THE PREFERRED EMBODIMENT

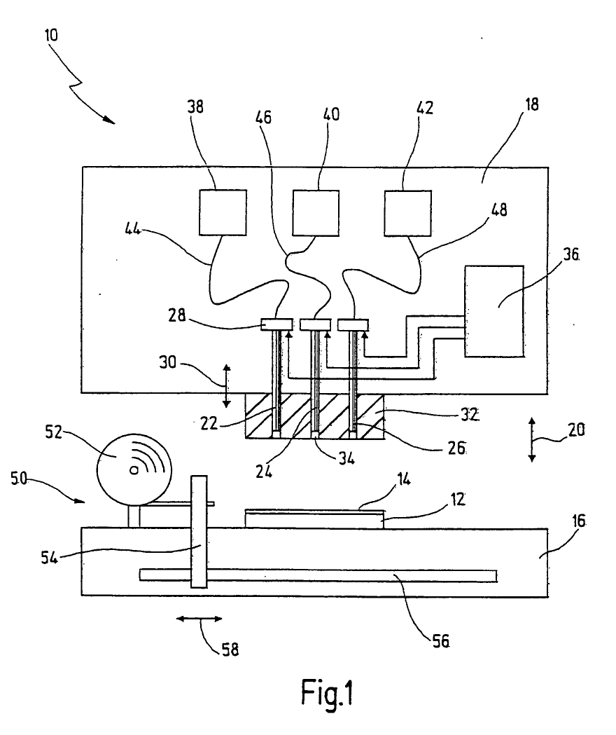

In FIG. 1, the device according to the invention is designated as a whole by the reference numeral 10.

The device 10 serves for the contacting of a microfluidic structure 12, on which, according to one aspect of the present invention, a layer 14 of elastic material is arranged. The microfluidic structure 12 is produced in a way known per se and has a number of micro-channels (not represented here), which can be filled with a fluid (likewise not represented here), in order for example to carry out a pharmaceutical analysis. The geometrical dimen-sions and characteristics of the microfluidic structure 12 correspond to those of microflu-idic structures of the generic type.

The layer 14 of elastic material is preferably produced from silicone or polyimide, but, depending on the application, it may also be made of rubber. Possibilities for the fastening of the elastic layer 14 on the microfluidic structure 12 are described in more detail below on the basis of preferred embodiments.

The microfluidic structure 12 here is clamped into a receptacle 16, that is known in a comparable way from DE 199 28 410 C2. Arranged above the receptacle 16 is a contact unit 18, which can move in relation to the receptacle 16 in the direction of the arrow 20. The contact unit 18 can in this way be lowered onto the microfluidic structure 12, in order to contact the microfluidic structure 12.

In the embodiment represented here, the contact unit 18 has three hollow needles 22, 24, 26, which are respectively connected to a drive 28 of their own. By means of the drive 28, each of the hollow needles 22, 24, 26 can be moved in relation to the contact unit 18 and in the direction of an arrow 30. In this case, the hollow needles 22, 24, 26 here are guided in a sliding piece 32, which has a corresponding guiding channel 34 for each individual hollow needle 22, 24, 26.

The hollow needles respectively have an outside diameter in the range of 200 □m. The inside diameter is approximately 100 □m. The spacings of the hollow needles from one another lie between 500 and 2000 □m. The diameters of the individual hollow needles 22, 24, 26 may also be different from one another. Hollow needles for the introduction of a fluid are preferably thinner and hollow needles for the removal or a fluid are preferably thicker (greater diameter).

Designated by the reference numeral 36 is a positioning unit, which is connected to the drives 28 for the hollow needles 22, 24, 26 via electrical control lines. With the aid of the positioning unit 36, each individual hollow needle 22, 24, 26 can be lowered separately from the others in the direction of the arrow 30. When the contact unit 18 has been lowered onto the microfluidic structure 12, the hollow needles 22, 24, 26 in this way enter individu-ally into corresponding access openings or directly into microchannels of the microfluidic structure 12. As explained in more detail below, the hollow needles 22, 24, 26 thereby pierce the elastic layer 14.

Designated by the reference numerals 38, 40, 42 are three reservoirs, in which there is respectively contained a fluid (a liquid or a gas), which is to be introduced into the micro-fluidic structure 12. The reservoirs 38, 40, 42 are respectively connected to a hollow needle 22, 24, 26, in each case via a fluid channel 44, 46, 48.

It goes without saying that the representation shown with three hollow needles 22, 24, 26, three reservoirs 38, 40, 42 and three fluid channels 44, 46, 48 has been chosen by way of example. Depending on the application, it is also possible for more hollow needles 22, 24, 26 to be connected to a common reservoir via a common fluid channel. Furthermore, the reservoirs 38, 40, 42 may also serve for the removal of fluids from the microfluidic struc-ture 12, in that a corresponding pump is provided for the intake of the fluid (not repre-sented here). In addition, as a departure from the representation chosen here with three hollow needles 22, 24, 26 and the corresponding number of fluid channels 44, 46, 48 and reservoirs 38, 40, 42, it is also possible to use any other number desired. In a currently preferred embodiment, seven hollow needles 22, 24, 26 are provided, activated individu-ally or in groups for the contacting of a microfluidic channel 12.

The positioning unit 36 is a control circuit which is preferably processor-based. The positioning unit 36 receives via suitable position sensors (not represented here), for exam-ple optoelectronic displacement transducers, positional information of the hollow needles 22, 24, 26 and calculates from this the control information for activating the drives 28. Corresponding open-loop and closed-loop control circuits are known per se in the prior art.

Designated here by the reference numeral 50 is an automatic mechanism with which the layer 14 of elastic material can be applied to the microfluidic structure 12. In this case, the automatic mechanism 50 comprises a reel 52, on which a supply of the elastic material is wound up. Here, this is, for example, a reel 52 with a polyamide film. Designated by the reference numeral 54 is a gripper unit, which is movable on a guide rail 56 in the direction of the arrow 58. The gripper unit 54 can pull a piece of the elastomeric material from the reel 52 and place it over the microfluidic structure 12. Subsequently, the layer 14 is separated from the reel 52.

In further variants (not represented here), the automatic mechanism comprises for example a supply of already made-up layers 14, which are deposited on the microfluidic structure 12 with the aid of the gripper unit 54. As an alternative to this, it is envisaged in other preferred embodiments to provide the microfluidic structure 12 with the layer 14 already during production, so that it is possible to dispense with the automatic mechanism 50 shown here within the device 10. In still further embodiments, it is envisaged to provide the microfluidic structure 12 with the layer 14 manually before the microfluidic structure 12 is placed in the receptacle 16 of the device 10.

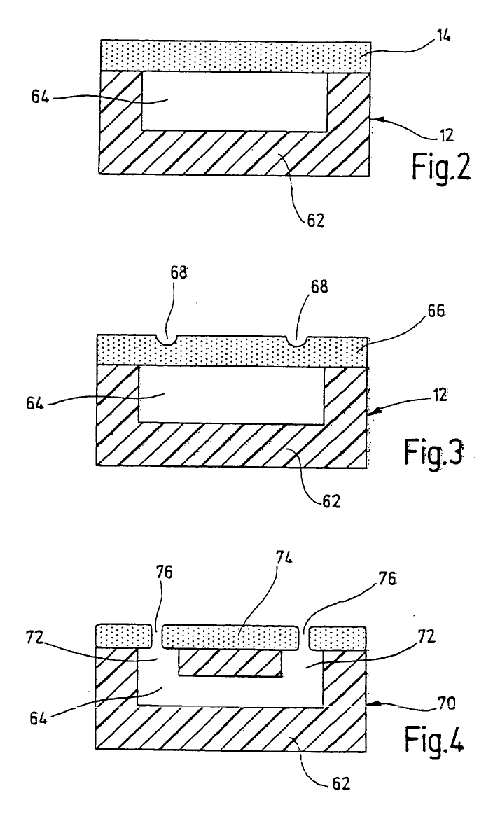

FIG. 2 shows a simplified cross-sectional view of the microfluidic structure 12, on which the layer 14 is arranged. For the sake of good order, it should be pointed out that the representation is not true to scale and, for the sake of simplicity, does not show a plurality of microchannels.

The microfluidic structure 12 comprises a substrate 62 of glass or silicone. Running in the substrate 62 is a microchannel 64, which is formed for example by an etching process on the upper side of the substrate 62. The microchannel 64 is covered on its open upper side by the elastic layer 14, which in some embodiments of the invention is fastened to the substrate 62, for example by adhesive bonding. In other embodiments of the invention, the layer 14 is only placed on the substrate 62 and in this way “loosely” covers the microchan-nel 64.

In FIG. 3, a further embodiment of a microfluidic structure is shown. The same reference numerals thereby designate the same elements as before. As a difference from the em-bodiment according to FIG. 2, however, the elastic layer, designated here by reference numeral 66, has a number of depressions 68, which make it easier for the hollow needles to enter the microchannel 64. This is so because, on account of the reduced material thick-ness, the depressions 68 form predetermined breaking points at which a hollow needle can more easily pierce the layer 66.

In the case of the embodiment according to FIG. 4, a microfluidic structure is designated by the reference numeral 70. The microfluidic structure 70 has in turn one or more micro-channels 64. As a difference from FIGS. 2 and 3, however, here the microchannel 64 runs inside the substrate 62, that is to say it is closed in the upper direction by the substrate 62. For the contacting of the microchannel or microchannels 64, there are access openings 72. As a difference from the previous embodiments, the elastic layer, designated here by the reference numeral 74, has micropores 76, which make it particularly easy for a hollow needle to enter. The dimensions of the micropores 76 are chosen such that the micropore 76 is closed by the entry of the hollow needle. In other words, the clear inside diameter of the micropore 76 preferably corresponds to the outside diameter of the hollow needle used, which is described below on the basis of further embodiments. In a further embodiment, the micropores 76 are slit-shaped openings, which open only when piercing with a hollow needle occurs and close again after removal of the needle.

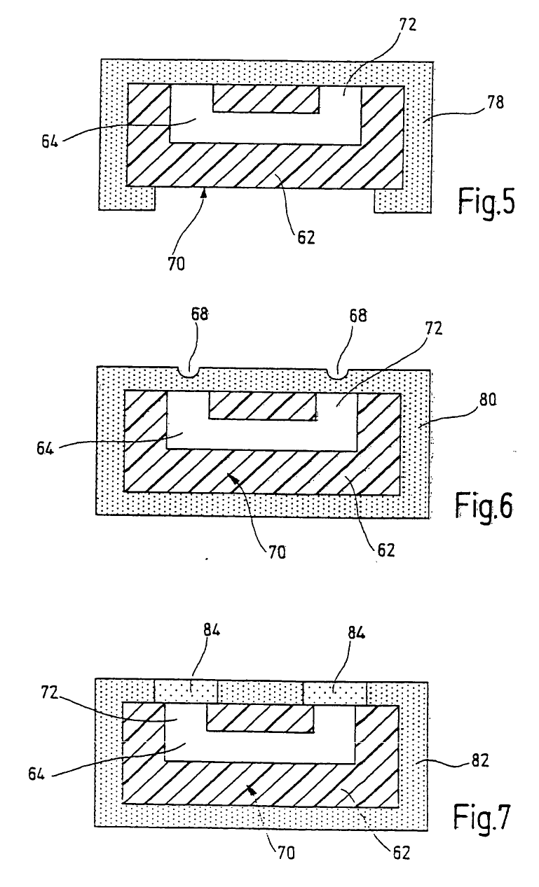

Shown in FIG. 5 is an embodiment in which the microfluidic structure 70 is largely enclosed by a layer 78. This embodiment is preferred if the elastic layer 78 is to be ar-ranged manually on the microfluidic structure 70.

Represented in FIG. 6 is an embodiment in which a layer 80 completely surrounds the microfluidic structure 70. In addition, here the layer 80 is in turn provided with depressions 68, in order to illustrate the varied combinational possibilities of the elements represented here.

Shown in FIG. 7 is a further exemplary embodiment, in which the microfluidic structure 70 is completely enclosed by a layer 82. In this embodiment, the layer 82 includes material spots 84 which consist of a softer material than the rest of the layer 82. Expressed in other terms, the layer 82 accordingly comprises a first material, which largely covers the micro-fluidic structure 70, and material spots 84 of a second material, which is softer than the first material. The material spots 84 form predetermined breaking points which make it easier for the layer 82 to be pierced with a hollow needle.

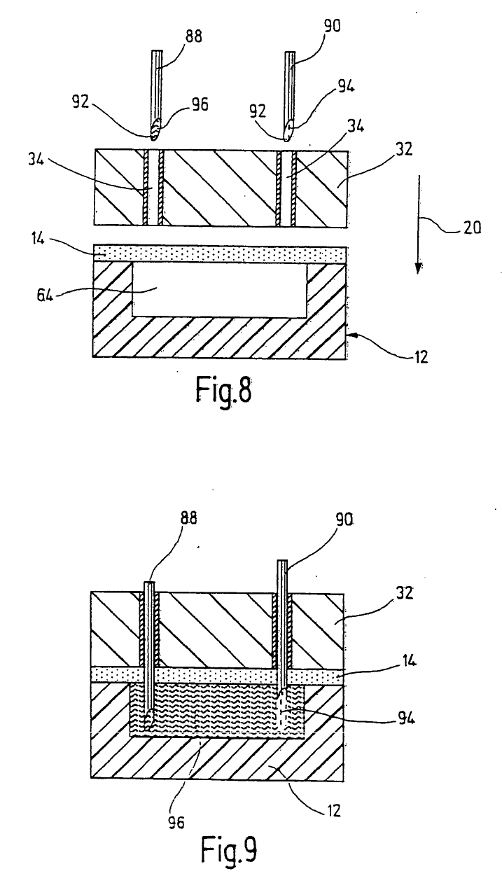

In FIGS. 8 and 9 it is shown in a simplified form how two hollow needles 88, 90 for the contacting of the microfluidic structure 12 enter the microchannel 64. In this embodiment, the hollow needles 88, 90 in each case have a penetrating tip 92, in order to make it easier to pierce the layer 14, which is homogeneous here.

As already referred to in the explanation of the device 10 in FIG. 1, the hollow needles 88, 90 are guided here in guiding channels 34 of a sliding piece 32, which makes precise and stable contacting possible and, moreover, reduces the risk of damage. In addition, when contacting takes place, the layer 14 is uniformly pressed by the sliding piece 32, which is of a flat form, against the microfluidic structure 70, which brings about good sealing. According to a preferred embodiment, the guide channels 34 are lined here on their inner sides with a sliding material, for example with a Teflon coating.

The embodiment represented here in FIGS. 8 and 9 shows a particularly preferred application, in which a first fluid 94 is introduced as a partial flow into a laminar enclosing flow of a second fluid 96. In order to determine the relative height of the first fluid 94 within the surrounding second fluid 96, here the hollow needles 88, 90 are made to enter the microchannel 64 to different depths.

In order to obtain particularly controlled conditions with respect to the two fluids 94, 96, in the embodiment represented here the hollow needles 88, 90 are filled with the correspond-ing fluids up to the outlet opening, that is to say in this case the penetrating tip 92, before entry in the microfluidic structure 12. Furthermore, here the second fluid 96 is introduced into the microchannel 64 first, to be precise in such a way that it completely fills the latter. By means of mechanisms known per se, the second fluid 96 is then set in a laminar flow within the microchannel 64, into which flow the first fluid 94 is then introduced at a defined height. The laminar flow may be produced for example by means of a correspond-ing pressure distribution inside the microchannel 64. If the fluids 94, 96 contain ions, electric fields can also be used for controlling the flow.

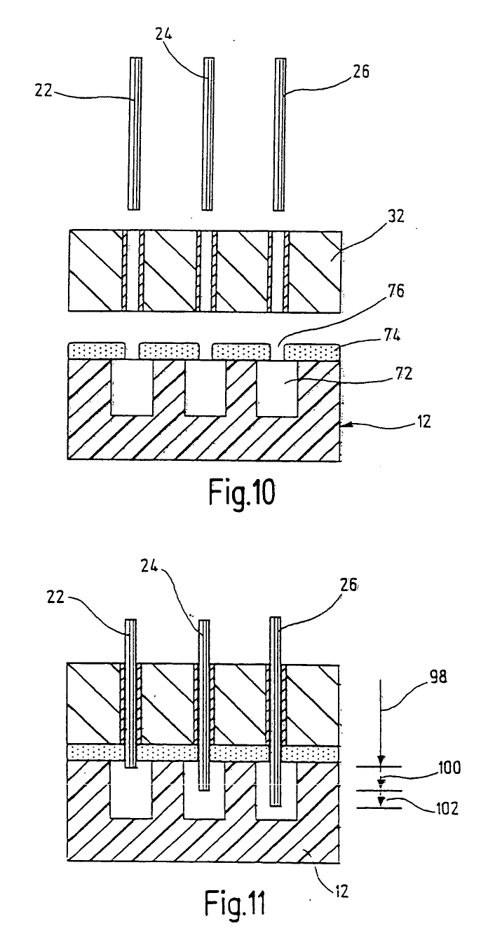

A further embodiment is represented in FIGS. 10 and 11. Here, the structure 12 is cov-ered by the elastic layer 74, which has micropores 76 above the access openings 72.

As shown in FIG. 11, the outside diameter of the hollow needles 22, 24, 26 is chosen such that it corresponds to the clear inside diameter of the micropores 76. When the hollow needles 22, 24, 26 have entered, a sealed closing of the microchannels is consequently produced. On account of the micropores 76 that are present, here the hollow needles 22, 24, 26 may have a blunt end.

In FIG. 11, the variable depth of entry of the individually activatable hollow needles 22, 24, 26 is represented once again with the aid of arrows 98, 100, 102.

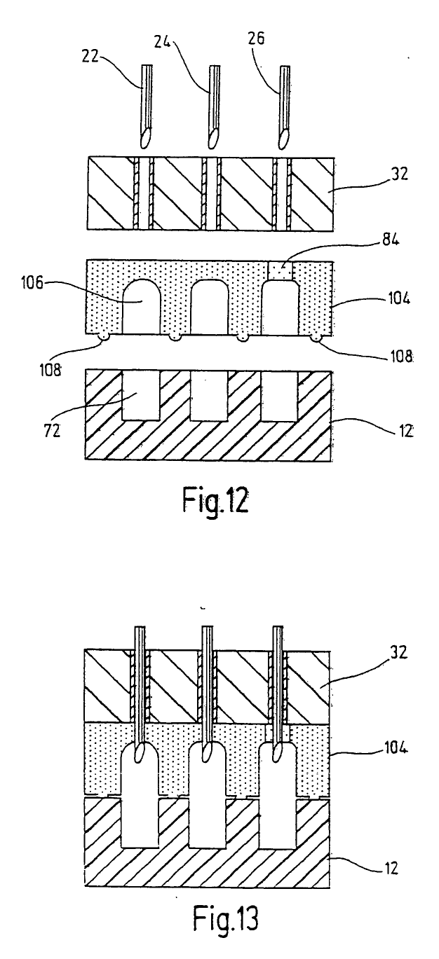

FIGS. 12 and 13 show further embodiments for the contacting of the microfluidic struc-ture 12. Here, the structure 12 is covered by a layer 104, which in comparison with the previously shown layers is relatively thick. In order to make the penetration of the hollow needles 22, 24, 26 easier, formed on the side of the layer 104 facing the microfluidic structure 12 are recesses 106 (represented here with different shaping), which respectively come to lie above the access openings 72. On account of the recesses 106, the layer 104 has in turn predetermined breaking points in the region of the access openings 72. To illustrate the varied combinational possibilities of the embodiments presented here, the layer 104 is also shown here by way of example with a material spot 84 which is softer than the remaining material of the layer 104. It goes without saying that the formation shown here of the layer 104 shows various variants in one representation.

A further feature of the layer 104 here are beads 108, which are arranged on the (lower) side facing the microfluidic structure 12. When the layer 104 is pressed onto the structure 12 with the aid of the sliding piece 32, the beads 108 form sealing rings around the access openings 72.

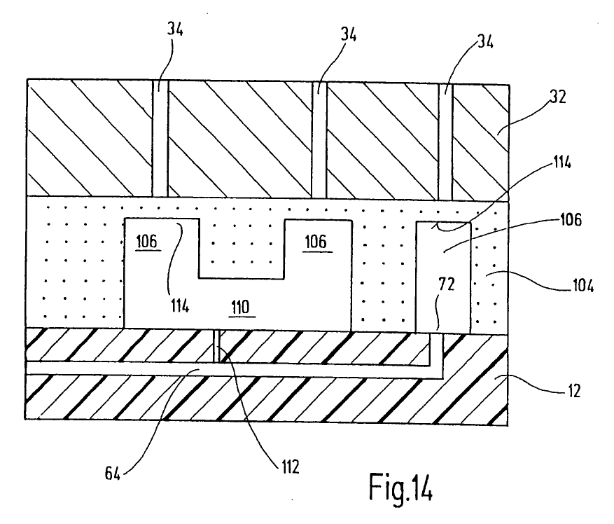

FIG. 14 shows in a configuration comparable to FIGS. 12 and 13 a microfluidic struc-ture 12 on which there is arranged a layer 104, on which in turn there is arranged a sliding piece 32, in which guide channels 34 are provided for hollow needles that are not shown in FIG. 14.

Provided in the layer 104 for each guide channels 34 is a recess 106, which can now be made comparatively thick. Only in the region in which the layer 104 is pierced by means of a hollow needle, running through the guide channels, the layer 104 is made very thin and soft.

The microchannel 64 is provided here within the microfluidic structure 12 and opens in the upward direction via an access opening 72. In addition, there is a contact channel 112, with which cells arranged on the opening of the contact channel 112 can be contacted, as is known per se in the case of microfluidic structures. In the manner of the patch-clamp technique, a cell arranged on the contact channel 112 can be perforated by a negative pressure exerted in the microchannel 64, so that contacting by liquid flowing in the micro-channel 64 is possible. However, other types of contacting of a cell positioned in such a way are also possible.

Provided in the layer 104 between the two recesses 106 on the left is a further microchan-nel 110, which forms on the microfluidic structure 12 as it were a reaction chamber, which can be filled for example through the guide channels 34 on the left with cells, substances etc., it being possible for material to be sucked out from the microchannel 110 through the middle guide channels 34.

Contacting and/or filling of the microchannel 64 in the microfluidic structure 12 may take place via the guide channels 34 on the right.

The height of the recesses 106, that is to say the distance from their base 114 to the micro-fluidic structure 12, is in this case dimensioned such that, when a hollow needle is made to pierce through the guide channels 34, the material of the layer 104 can bulge elastically downward before the hollow needle breaks through, without any risk of the material of the layer 104 being punched out or touching the microfluidic structure 12, or of the hollow needle striking the microfluidic structure 12 because of a counterpressure suddenly relax-ing.

In simple embodiments, the hollow needles for the penetration of the layers are produced from metal. However, the surface of the hollow needles is then preferably coated with a nonconducting layer, for example anodized aluminum or Teflon. The formation of this type additionally has the advantage that no metal ions can be detached from the hollow needles on contact with the fluids.

In alternative embodiments, the hollow needles are produced from a nonconducting material, for example ceramic, rigid plastic or glass.

The type of contacting shown here allows the dead volume in the access lines to be kept very small, which makes it possible in particular to process extremely small amounts of a substance sample.

What is claimed is:

1. A device for contacting a microfluidic structure,
said microfluidic structure having at least one microchannel and one access opening connected to said microchannel for introducing a first fluid into said microchannel, a layer of elastic material arranged on the microfluidic structure for closing off said access opening,
said device comprising a receptacle for housing the microfluidic structure, and a contact unit having at least one fluid channel that is arranged to be connected to said access opening,
whereby said contact unit comprises at least one hollow needle that is connected to said fluid channel and designed for piercing said layer of elastic material.

2. The device of claim 1, wherein said contact unit includes a sliding piece for movably guiding said at least one hollow needle.

3. The device of claim 2, wherein said sliding piece is formed such that during said piercing of said layer said sliding piece presses onto the microfluidic structure.

4. The device of claim 1, wherein said contact unit has a number of hollow needles for piercing said layer of elastic material, said number of hollow needles being controlled separately from one another.

5. The device of claim 1, wherein a positioning unit is provided for controlling a variable depth of entry of said hollow needle into said microchannel.

6. The device of claim 4, wherein a positioning unit is provided for controlling a variable depth of entry of each of said hollow needles into said microchannel.

7. The device of claim 1, wherein an automatic mechanism is provided for arranging said layer of elastic material on said microfluidic structure.

8. The device of claim 1, wherein said at least one hollow needle has a penetrating tip.

9. The device of claim 1, wherein said layer of elastic material is provided with at least one recess facing said microfluidic structure, whereby said recess is arranged above said at least on access opening.

10. The device of claim 4, wherein said layer of elastic material is provided with at least one recess facing said microfluidic structure, whereby said recess is arranged above said at least on access opening.

11. The device of claim 6, wherein said layer of elastic material is provided with at least one recess facing said microfluidic structure, whereby said recess is arranged above said at least on access opening.

12. A device for contacting a microfluidic structure,
said microfluidic structure having at least one microchannel and one access opening connected to said microchannel for introducing a first fluid into said microchannel, a layer of elastic material arranged on the microfluidic structure for closing off said access opening,
said device comprising a receptacle for housing the microfluidic structure, and a contact unit having at least one fluid channel that is arranged to be connected to said access opening,
whereby said contact unit comprises at least one hollow needle that is connected to said fluid channel and designed for piercing said layer of elastic material,
wherein said layer of elastic material is provided with at least one recess facing said microfluidic structure, whereby said recess is arranged above said at least on access opening.

13. The device of claim 12, wherein said contact unit has a number of hollow needles for piercing said layer of elastic material, said number of hollow needles being controlled separately from one another.

14. The device of claim 13, wherein a positioning unit is provided for controlling a variable depth of entry of each of said hollow needles into said microchannel.

15. A microfluidic structure, in particular for pharmaceutical, chemical or biochemical analysis of fluidic substances, said microfluidic structure having at least one microchannel and at least one access opening connected to said microchannel, whereby a layer of elastic material is provided which closes off said access opening.

16. The microfluidic structure of claim 15, wherein said layer of elastic material is provided with a predetermined bra-king point that is located above said access opening.

17. The microfluidic structure of claim 15, wherein said layer of elastic material is firmly connected to said microfluidic structure.

18. The microfluidic structure of claim 15, wherein said layer of elastic material comprises at least one recess facing said microfluidic structure and arranged above said at least one access opening.

19. The microfluidic structure of claim 16, wherein said layer of elastic material comprises at least one recess facing said microfluidic structure and arranged above said at least one access opening.

20. The microfluidic structure of claim 15, wherein said layer of elastic material is provided with beads facing said microfluidic structure and forming sealing lips around said access opening.

21. The microfluidic structure of claim 18, wherein said layer of elastic material is provided with beads facing said microfluidic structure and forming sealing lips around said access opening.

22. The microfluidic structure of claim 15, wherein said layer of elastic material is provided with at least one microchannel facing said microfluidic structure.

23. A microfluidic structure, in particular for pharmaceutical, chemical or biochemical analysis of fluidic substances, said microfluidic structure having at least one microchannel and at least one access opening connected to said microchannel, whereby a layer of elastic material is provided which closes off said access opening, wherein said layer of elastic material comprises at least one recess facing said microfluidic structure and arranged above said at least one access opening.

24. The microfluidic structure of claim 23, wherein said layer of elastic material is provided with a predetermined bra-king point that is located above said access opening.

25. A microfluidic structure, in particular for pharmaceutical, chemical or biochemical analysis of fluidic substances, said microfluidic structure having at least one microchannel and at least one access opening connected to said microchannel, whereby a layer of elastic material is provided which closes off said access opening, wherein said layer of elastic material is provided with a predetermined braking point that is located above said access opening.

26. A method for making contact to a microfluidic structure, said microfluidic structure having at least one microchannel and one access opening connected to said microchannel for introducing a first fluid into said microchannel, said method comprising the steps of:
arranging a layer of elastic material above said access opening for closing off said access opening,
piercing said layer of elastic material by means of at least one hollow needle; and
introducing said first fluid into said microchannel through said at least one hollow needle.

27. The method of claim 26, wherein said hollow needle is guided within a sliding piece when piercing said layer of elastic material.

28. The method of claim 27, wherein said sliding piece is pressed onto said layer of elastic material at least when said at least one hollow needle is pierced through said layer of elastic material.

29. The method of claim 26, wherein said hollow needle comprises an outlet opening and is filled with said first fluid up to said outlet opening before it is pierced through said layer of elastic material.

30. The method of claim 26, wherein said microchannel is completely filled with said second fluid before introducing said first fluid.

31. The method of claim 26, wherein said hollow needle is inserted into said access opening with an adjustable depth of entry before introducing said fluid.

32. The method of claim 26, wherein said layer of elastic material comprises projecting beads facing said microfluidic structure and forming sealing lips around said access opening.

33. The method of claim 26, wherein said microfluidic structure is at least partially surrounded by an enclosing form of said elastic material for arranging said layer of elastic material on said microfluidic structure.
